(19) United States
(12) Patent Application Publication
(10) Pub. No.: US 2007/0090684 A1
(43) Pub. Date: Apr. 26, 2007

(54) Rim, and method for manufacturing a rim

(76) Inventor: Gerrit Jager, Pery (CH)

Correspondence Address: GREER, BURNS & CRAIN, 300 S WACKER DR, 25TH FLOOR, CHICAGO, IL, 60606, US

(21) Appl. No.: 11/585,750

(22) Filed: Oct. 24, 2006

(30) Foreign Application Priority Data
Oct. 26, 2005 (DE) 10 2005 051 531.2

(51) Int. Cl. B60B 21/06

(52) U.S. Cl. 301/58

(57) ABSTRACT

A rim and a method for manufacturing a rim, in particular for a bicycle, includes a rim body and multiple spoke holes in the rim body for receiving at least part of a spoke and/or spoke nipple. The rim body consists of a fiber-reinforced material including a thermoplastic matrix material. Separate rim eyelets are provided located at the spoke holes and connected with the rim body.

### BACKGROUND

The invention relates to a rim and a method for manufacturing a rim, in particular for bicycles.

Bicycle rims are subjected to high standards. In the area of sports and in particular in the professional and semi-professional field the weight and stress tolerance of a bicycle component play a decisive role. The weight of rims is doubly significant since the rim weight per se contributes to the total weight on the one hand and on the other hand the weight of the rims plays a role due to inertia in accelerating and decelerating.

The rim must also withstand the loads applied to it occurring e.g. on bumpy roads. With mountain bikes, jumps cause particularly high loads that must be absorbed through the rim and transferred via the spokes. Then again, each gram of weight counts in bicycle racing.

A wheel comprises a rim and as a rule a number of spokes which establish the connection between the central hub and the rim. For receiving the spoke nipples, most rims are provided with spoke holes in which the spoke nipples are positioned and then screwed to the spokes.

Spoke breakage during operation may considerably decrease bicycle safety and any causes of spoke breakage should therefore be minimized as much as possible.

Apart from external causes such as improper handling and use of force, material fatigue in spokes is one of the most frequent causes for spoke breakage wherein material fatigue breaks will occur as the fatigue limit is exceeded.

In a rolling bicycle wheel, the operating load subjects a spoke to alternating compressive and tensile forces wherein given a load of for example 900 N (corresponds to about 90 kg weight load) and e.g. 32 spokes, said force being distributed, for example, over about three tension spokes and three compression spokes, about 300 N pull are basically applied to a tension spoke in addition to its pre-stress and a compression spoke is relaxed from the pre-stress by about 300 N.

Therefore, spoke pre-stress must be selected high enough so that a sufficiently high residual stress (pre-stress less compressive stress) will remain even when the load applied is high. On the other hand, the maximum load on a tension spoke (pre-stress plus tensile stress) must remain within the range of elasticity of the spoke. The spokes of a rolling wheel are therefore subjected to a varying tensile stress at an amplitude of 300 N in the selected example. Fatigue fractures of spokes frequently occur in the region of the thread. If, however, the spoke pre-stress is dimensioned appropriately, the spoke shaft pre-stressed in the range of elasticity will absorb the oscillating loads at a high fatigue strength, so as to unload the thread and to largely prevent fatigue fractures. This means that with the pre-stress high enough, material fatigue and ensuing spoke breakage are inhibited.

To provide the wheel with reliable performance characteristics the spokes are therefore subjected to a corresponding stress level. The rim must in turn withstand the high local loads.

Weight is saved in the field of bicycles by using fiber reinforced materials since these combine a high stress tolerance with a low weight. It is, however, a disadvantage of the fibrous composite materials which are generally used e.g. with epoxy resin as the matrix material that said fibrous composite materials with a thermosetting matrix material are brittle and their impact-resistant properties low.

The high loads and jolt-like bumps applied via the spokes or spoke nipples in exceptional stresses may cause breakage of the fibrous composite material of the rim. To keep the stress tolerance of the rim high even when fibrous composite materials are employed, e.g. small steel insert plates are glued onto the finished rim at the rim holes to provide the rim with local reinforcement. The disadvantage is, however, that inserting the plates requires much time and is therefore expensive. It is another disadvantage that the weight of the insert plates is rather high.

Therefore it is the object of the present invention to provide a durable and stable rim in particular for a bicycle which is relatively lightweight and easy to manufacture.

### SUMMARY

A rim according to the invention is in particular provided for use with a bicycle. The rim comprises a rim body and multiple spoke holes in the rim body, each receiving at least part of a spoke link or a spoke and/or spoke nipple. The rim body consists at least in part of a fibrous composite material with a thermoplastic matrix material. As a reinforcement for the rim holes, separate rim eyelets are provided located at the spoke holes and connected with the rim body.

The invention has considerable advantages. Using a fiber-reinforced material with a thermoplastic matrix material is very advantageous since a thermoplastic fibrous composite material is elastic and less brittle than a thermosetting fibrous composite material. A fibrous composite material of a thermoplastic matrix material is thus not prone to splinter fractures.

Due to the brittleness of thermosetting matrix materials, rim eyelets could thus far not be used with rims of fibrous composite materials because the risk of breakage while inserting the spokes into the eyelets is too high. The use of metal platelets and gluing them onto the rims is considerably more complex and thus more expensive than application of eyelets to the rims according to the invention.

Preferably the rim eyelets are firmly affixed to the rim body. Preferably the rim eyelets are affixed to the rim body to be rotationally secure or non-rotatable. Such a junction is significant to prevent that the rim eyelet rotates along with the spoke nipples being screwed into place. Such a following rotation might result in damage to the rim.

The matrix material consists in particular of a material from a group of materials comprising material families including, polyphenylene sulphide (PPS), polyetherimide (PEI), polyether sulfone (PES), polyetherether ketone (PEEK) and polyether ketone. Preferably the matrix material is selected from a group of materials comprising polyamide, polyethylene terephthalate, polyether and polycarbonate. Using thermoplastic fibers of polyamides is particularly preferred. Such polyamides are thermoplastic materials consisting of organic macromolecules (polymers) whose monomer units are bonded through polycondensation between a carboxylic group and an amino group. Preferred fibers are e.g. nylon fibers.

A preferred specific embodiment provides for at least one rim eyelet comprising an eyelet head, an eyelet hollow, and an eyelet base. It is particularly preferred that the eyelet head radially externally contacts a rim base of the rim body. The eyelet head is provided for contacting a spoke nipple in a wheel. The eyelet hollow preferably extends through a hole in a rim base of the rim body and the eyelet base preferably at least partially contacts the bottom surface of a rim base of the rim body radially inwardly.

Such a configuration of rim eyelets will achieve a tight fit at the rim. This is advantageous for guaranteeing safe operation. Thus the rim eyelet is secured against loss. Loss of metal plates due to ungluing as is possible in the prior art is thus reliably prevented.

It is particularly preferred that the eyelet base is bordered, comprising a bordering. The bordering of the rim eyelet in particular engages with local deformations of the rim body. This is because bordering of the eyelet base will achieve not only a frictional fit at the rim body but also a form fit. A particularly secure fit of the rim eyelet is achieved such that as a rule the rim eyelet will not follow the rotation of a spoke nipple being screwed in. The durability of the rim increases.

Preferred specific embodiments provide for the eyelet to be at least partially of metal, in particular of steel. It is also conceivable to provide plastic rim eyelets.

A steel rim eyelet shows a particularly high stress tolerance. Although the specific weight of steel is high, the weight of each rim eyelet is low since only a small diameter and minimum thickness are required. Therefore the weight of a rim eyelet is in particular lower than the weight of the rim plates known from the prior art. One of the reasons therefor is that the rim eyelet is held to the rim body through form-fit rather than through a layer of glue which would require a specific volume for an efficient support. Additionally a thermoplastic matrix material allows local deformation of the eyelet and the rim body without the hazard of brittle fractures.

In advantageous further embodiments the eyelet comprises a coating layer made from a material providing a lubricating effect. Preferably the coating consists of a non-volatile material, in particular a material taken from a group of materials including metallic materials, graphite mixed with binders, molybdenum, nickel, and polytetrafluoroethylene.

This is very advantageous for suitably adjusting the spoke stress in a wheel having the rim according to the invention. A friction-reducing layer between the spokes or the spoke nipples and the rim will decrease the effects of hysteresis. This will allow to better adjust the acting force when tightening the spoke nipple such that the screwing torque will not be substantially employed for overcoming the friction between the spoke nipple and the rim.

The lubricating effect should therefore be present even with high pressures. In this case it is not sufficient to use a standard lubricating oil since it would not be effective with the high surface pressures occurring between spoke nipple and rim eyelet. In general materials are preferred where the lubricating effect which is provided with the high surface pressures occurring between spoke nipple and rim eyelet will be and remain effective for months and in particular for years so as to provide a lubricating effect even in later readjustments of the spoke stress.

The coating is deposited in particular on the outwardly eyelet face. Coating may be present on the outside and the inside e.g. for rim eyelets manufactured by dipping.

Preferably the rim is configured as a hollow rim. The rim body comprises a hollow with a radially outwardly rim well and a radially inwardly rim base. Lateral strips serve as rim flanges.

The method for manufacturing a rim according to the invention comprises at least the following steps:
a) placing fibers in a rim mold,
b) heating the fibers,
c) cooling the rim body,
d) inserting rim eyelets as reinforcements for the rim holes in the rim body.

Before inserting the rim eyelets, the rim holes may be made by perforating the rim body unless said holes are manufactured directly with the rim. Producing rim holes in rims of thermoplastic matrix material is easy because working by cutting is possible. Since the material is not prone to brittle fractures, rim holes may be bored or milled. For components of thermosetting fibrous composite material, however, cutting the element is difficult.

With the rim according to the invention it is preferred that rim holes are automatically manufactured by a machine which rotates the rim by predetermined angular increments, manufacturing rim holes autonomously.

Preferred specific embodiments provide that at least two different fiber types are employed namely, a first fiber type of a thermoplastic material and a second type of reinforcing fibers.

In other preferred specific embodiments at least some fibers are combination fibers consisting both of reinforcing fibers and a thermoplastic material. Combination type fibers include portions of both thermoplastic material and reinforcing fibers. In this case it is preferred to have the core fiber consisting of a reinforcing fiber (or multiple reinforcing fibers) and the sheath, of a thermoplastic material. It is also possible to have the core fiber consisting of a combination fiber of a thermoplastic material and the sheath, of one or multiple reinforcing fibers.

Also, the combination fibers may comprise intermittent sections of thermoplastic material and reinforcing fibers in the longitudinal direction. The individual sections may overlap.

In all of the cases, glass fibers or carbon fibers may be provided as the reinforcing fibers.

Employing three or more different fiber types is also possible and preferred. In addition to the reinforcing fibers and thermoplastic fibers described above, for example combination fibers may be used. This allows a flexible configuration of the bicycle component.

An advantageous specific embodiment of the method provides for the rim eyelets to be fitted into the rim holes of the rim body. To this end the rim eyelets are placed into the rim holes and then the edges are bordered. Force will be applied to plastically deform at least the eyelet base. The rim body will thus be plastically deformed locally so as to achieve a form-fit connection of the rim eyelet with the rim body.

It is a quite considerable advantage of employing rim eyelets that said rim eyelets can be automatically inserted by a machine. This is not possible with the prior art rim plates such that the operation in manufacturing the rims according to the invention is considerably reduced in comparison.

In preferred specific embodiments and configurations the rim eyelets are inserted one by one into the rim body. The rim will be rotated by the corresponding angular distance and the rim eyelet inserted into a free rim hole. Concurrent inserting of all or multiple rim eyelets is possible as well. Inserting occurs in particular mechanically.

To allow enhanced mounting of a wheel having a rim according to the invention, the rim eyelet may be coated with a material providing a lubrication effect as described above.

It is preferred to employ fibers joined to one another in manufacturing. The fibers are in particular interconnected by a method selected from a group of methods including machine knitting, weaving, knotting, knitting, braiding, and spinning. It is in particular preferred to employ prepregs or prefabricated tissues, hoses, mats and/or profiles.

Heating occurs preferably in a stove or the like. Heating occurs preferably at a temperature of at least 150° C., in particular at least 170° C., preferably at least 200° C. or 220° C. The exact temperature depends on the specific conditions and materials and may in particular be higher. It is important not to exceed the melting temperature of the thermoplastic fibers. For determining the temperature, the mold may be provided with a temperature sensor emitting e.g. a radio signal as the preset temperature is reached. It is also possible to have a signal emitted when temperature changes become insignificant over a specified period.

Heating may occur through the actual mold e.g. by embedded heating wires, or through a stove or irradiation or through induction.

Preferably the rim is heated for a period of at least 2 minutes. The time period is in particular between approximately 2 and 30 minutes, preferably approximately 5 to 10 minutes.

Heating is followed by cooling which may occur in ambient air and can be accelerated by way of air supply. Preferably a liquid is employed for cooling. Water is in particular suitable. Cooling may be carried out by spraying or immersion. Cooling by quenching is in particular preferred. The mold may be immersed into the quench tank e.g. for 1 minute, 3 minutes or 10 minutes. The mold will then be available for manufacturing another rim within a very short time.

Manufacturing rims of a thermoplastic matrix material also offers the advantage that a small quantity of molds is sufficient for manufacturing a higher number of rims within the same time since heating times can be kept short. Thermoplastic materials do not require any reaction between two components as do thermosetting materials but it is sufficient for the matrix material to melt and to distribute homogeneously. This will considerably increase the capacity per mold. A factor of 2 to 4 is conceivable and realistic. This will render the component more cost-effective since the proportion of the mold in the price will decrease.

In manufacture, an inner winding core or core may be used around which the fibers are wound or on which they are deposited. The wrapped core is then placed in the mold. The core may permanently remain e.g. in the rim hollow or it may be removed. The core is in particular flexible and expandable e.g. by inflating. In this case the core will expand in particular during heating so as to generate internal pressure against the layers of fibers or fabric.

### BRIEF DESCRIPTION OF THE DRAWINGS

Further advantages and embodiments of the present invention follow from the embodiments which will now be described with reference to the attached drawings.

FIG. 1 is a wheel having a rim according to the invention in a lateral view,

FIG. 2 is the wheel in FIG. 1 depicted in section,

FIG. 3 is a schematic cross-section through a rim according to the invention, and

FIG. 4 is a schematic cross-section through another rim according to the invention.

### DETAILED DESCRIPTION OF THE PREFERRED EMBODIMENTS

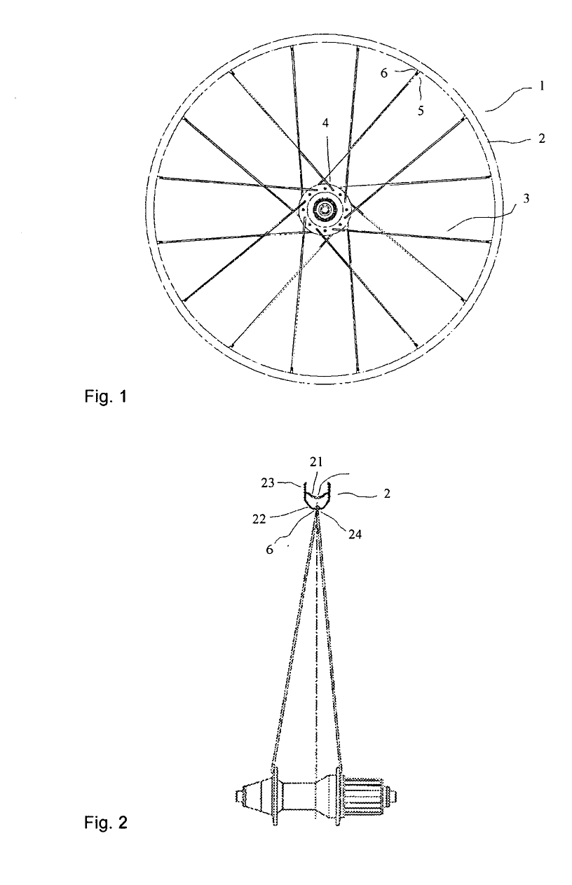

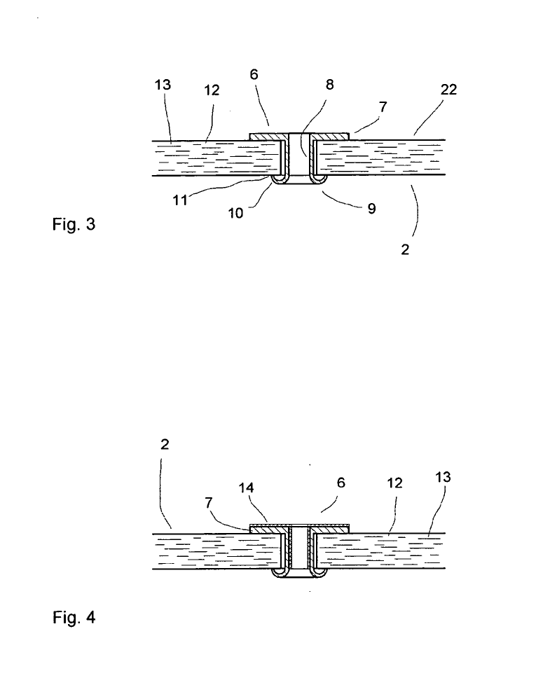

With reference to the FIGS. 1 to 3 a first embodiment of the invention will now be described by exemplifying the use of the rim according to the invention with a wheel of a bicycle.

FIG. 1 shows a lateral view of a wheel 1 with a rim 2 according to the invention. The rim 2 consists of a fibrous composite material with a matrix material 12 and reinforcing fibers 13 wherein the matrix material 12 is a thermoplastic material such as polyamide.

The rim 2 is connected via spokes 3 and spoke nipples 5 to the hub 4. Between the rim base 22 and each spoke nipple, rim eyelets 6 are provided.

The rim 2 in this case is manufactured of prepregs deposited on a core in a mold. The mold is closed and heated for approximately 10 to 15 minutes such that the thermoplastic matrix material melts and distributes homogeneously while pressure is applied externally. After cooling the mold, the rim is removed and the rim holes 24 are automatically punched by a machine, being distributed over the periphery. Cooling occurs in particular through quenching.

Each rim hole 24 is automatically provided with a rim eyelet 24 being mechanically inserted into the rim hole and then bordered by means of pressure applied to both ends of the rim eyelet so as to achieve a frictional and form-fitting connection. At the local contact areas 11 of the rim eyelets 6 with the rim base 2, the rim base 22 is plastically deformed. The pressure applied to the rim eyelet 6 generates the bordering 10 at the eyelet base. The eyelet head 7 lies flat against the radially outwardly face of the rim base 22 while the eyelet hollow 8 extends through the rim base 22. All or part of the eyelet base 9 lies against the radially inwardly face of the rim base 22.

As is illustrated schematically in FIG. 4, the rim eyelet 6 may comprise an additional coating 14 of a non-volatile material to achieve a lubricating effect. The lubricating coating 14 results in improved rotating of the spoke nipples in the rim eyelets such that the desired spoke pre-stress is better adjustable.

1. A rim, in particular for a bicycle, comprising,
a rim body and multiple spoke holes in the rim body each receiving at least part of a spoke and/or spoke nipple;
said rim body consists of a fiber-reinforced material comprising a thermoplastic matrix material; and
wherein separate rim eyelets are provided which are located at the spoke holes and connected with the rim body.

2. The rim according to claim 1, characterized in that the rim eyelets are fixedly attached to the rim body.

3. The rim according to claim 1, characterized in that the rim eyelets are non-rotatably attached to the rim body.

4. The rim according to claim 1, characterized in that the matrix material is selected from a group of materials including polyamide, polyethylene terephthalate, polyether and polycarbonate.

5. The rim according to claim 1, wherein at least one rim eyelet comprises an eyelet head, an eyelet hollow, and an eyelet base.

6. The rim according to claim 1,
wherein the eyelet head radially externally contacts a rim base of the rim body and is provided for contacting a spoke nipple,
and wherein the eyelet hollow extends through a hole in a rim base of the rim body,
and wherein the eyelet base radially inwardly contacts the bottom surface of a rim base of the rim body.

7. The rim according to claim 5, characterized in that the eyelet base comprises a bordering.

8. The rim according to claim 1, wherein the eyelet consists at least partially of a metal, in particular steel.

9. The rim according to claim 1, wherein the eyelet comprises a coating consisting of a material providing a lubricating effect.

10. The rim according to claim 9, wherein the rim has a coating of a non-volatile material consisting of a material taken from a group of materials including metallic materials, graphite mixed with binders, molybdenum, nickel, and polytetrafluoroethylene.

11. The rim according to claim 9, wherein the coating is deposited on the outside of the eyelet.

12. The rim according to claim 1, wherein the rim body comprises a hollow with a radially outwardly rim well and a radially inwardly rim base and lateral strips serving as rim flanges.

13. A wheel with a rim according to claim 1.

14. A method for manufacturing a rim where at least the following steps are carried out:
a) placing fibers in a rim mold;
b) heating the fibers;
c) cooling the rim body; and
d) inserting rim eyelets as reinforcements for the rim holes in the rim body.

15. The method according to claim 14, wherein at least two different fiber types are employed namely, a first fiber type of a thermoplastic material and a second type of reinforcing fibers.

16. The method according to claim 14, wherein at least some of the fibers are combination fibers consisting of a fiber core with at least one reinforcing fiber and a sheath of a thermoplastic material.

17. The method according to claim 14, wherein the rim eyelets are placed in the rim holes of the rim body and then bordered such that a plastic deformation of the eyelet and/or the rim body occurs.

18. The method according to claim 17, wherein the rim eyelets are inserted automatically and mechanically.

19. The method according to claim 18, wherein the rim eyelet is provided with a coating providing a lubricating effect.

20. The method according to claim 14, wherein interconnected fibers are employed which are interconnected in particular by means of a process selected from a group of processes including machine knitting, weaving, knotting, knitting, braiding, and spinning.

21. The method according to claim 20, wherein prefabricated tissues, hoses, mats and/or profiles are employed.

22. The method according to claim 14, wherein heating is carried out in a stove at a temperature of at least 150° C. which in particular occurs at least for a period of 2 minutes, in particular for a period of 5 to 30 minutes.

23. The method according to claim 14, wherein cooling is carried out with a liquid.
